(19) United States
(12) Patent Application Publication
(10) Pub. No.: US 2006/0186229 A1
(43) Pub. Date: Aug. 24, 2006

(54) Fluid jet nozzle

(76) Inventor: Elliot M. Cotler, Brooklyn, NY (US)

Correspondence Address: SCHWEITZER CORNMAN GROSS & BONDELL LLP, 292 MADISON AVENUE - 19th FLOOR, NEW YORK, NY, 10017, US

(21) Appl. No.: 11/061,711

(22) Filed: Feb. 22, 2005

(51) Int. Cl. B05B 1/20

(52) U.S. Cl. 239/566; 239/592; 239/594

(57) ABSTRACT

An improved fluid jet nozzle, having particular utility in the textile field, has a body with an air inlet for a pressurized fluid, such as air, a manifold, and an outlet. The outlet is in the form of parallel series of outlet apertures, the apertures of a series being laterally offset from the outlet apertures of an adjacent series. The outlet apertures may be formed as portions of slots in shims mounted in the nozzle. The aperture configuration provides for better balance between overall flow uniformity and economical fluid usage.

The present invention relates to a fluid jet nozzle construction and particularly to such a construction which may have particular utility in the textile field.

### BACKGROUND OF THE INVENTION

The use of jets or streams of pressurized fluids, such as air and other gasses, for cleaning purposes is well known. Such jets may be of particular value when the device or mechanism to be cleaned cannot be contacted by brushes and the like because of its construction or mode of operation, its sensitivity, or the like, or when the device or mechanism is inaccessible to mechanical contact. In the textile machinery field, in particular, air jet systems find wide applicability for purposes of keeping needles, cams and other mechanisms free of lint, thread particles, dust and other debris.

Often, when a particular location of relatively small dimensions is to be cleaned, a single aperture-type air jet nozzle can be employed. Such a construction provides a relatively narrow and focused air jet, which can be aimed at the specific target location. When a plurality of discrete locations is targeted, a series of individual nozzles, each aimed as required, can be utilized.

As an alternative to a plurality of discrete nozzles, U.S. Pat. No. 4,869,080 discloses an air jet nozzle type device for lint-removing which comprises a freely-suspended flexible tube which vibrates or flutters as a result of the passage of the high pressure gas therethrough. The flutter causes the air jet to sweep over an area much greater than the cross section of the jet flow, but has a more limited range of effective distance and pressure settings then rigid nozzles. Thus, while the flutter tube provides an economical means for a broadened spray, it can be of limited value when there is need for wider and more accurate control over the target area.

It is accordingly a purpose of the present invention to provide a new and improved fluid jet nozzle construction that provides for an accurate and efficient fluid jet having a wide target area.

Yet a further purpose of the present invention is to provide such a nozzle having an economical construction, which allows the fluid jet characteristics to be modified in a simple and economical manner, and which is economical in fluid volume usage.

Still a further purpose of the present invention is to provide a flow control insert for a fluid jet nozzle construction which allows a wide area, targeted outflow to be generated, and which can be in the form of interchangeable inserts for the nozzle to allow the simplified modification of the nozzle's output flow characteristics.

### BRIEF DESCRIPTION OF THE INVENTION

In accordance with the foregoing and other objects and purposes, the fluid jet nozzle of the present invention comprises a nozzle body having an inlet for a compressed or pressurized fluid, such as air or another gas, an internal manifold into which the fluid directed, and an outlet for forming a series of independent output fluid jets which subsequently merge to form an overall jet flow in the desired pattern. The outlet may comprise a plurality of outlet apertures aligned in series of parallel rows, the outlet apertures of adjacent rows being laterally offset from each other to generate the independent series of jets. The resulting overall flow has a cross section that allows a relatively large target area to be covered with the aiming facility of a single fixed jet. The staggered apertures provide for better balance between overall flow uniformity and economical fluid usage. The number and dimensions of the output apertures may be chosen in accordance with the desired overall flow rate and dispersion desired.

The nozzle may further comprise a series of flat shims in which the outlet apertures are formed by portions of slots milled in the shims. The shims are so constructed that, when stacked together, the slots portions in adjacent shims are offset, while other portions of the slots are in register and are in fluid communication with the nozzle manifold. The shims are interchangeably mounted in the nozzle, facilitating modification of the nozzle's flow characteristics as desired.

### BRIEF DESCRIPTION OF THE DRAWINGS

A fuller understanding of the present invention will be obtained upon review of the following detailed description of a preferred, but nonetheless illustrative embodiment thereof, when considered in conjunction with the annexed drawings, wherein:

FIG. 1 is a perspective view of an air jet nozzle of the present invention;

FIG. 2 is an exploded perspective view of the nozzle of FIG. 1;

FIG. 3 is a top plan view of a shim of the present invention;

FIG. 4 is a front elevation view of a shim pair depicting the orientation of the outlet slot portions therein;

FIG. 5A is a perspective view of an alternative slot construction for a shim pair; and

FIG. 5B is a detail of a portion of the shims of FIG. 5A.

### DETAILED DESCRIPTION OF THE INVENTION

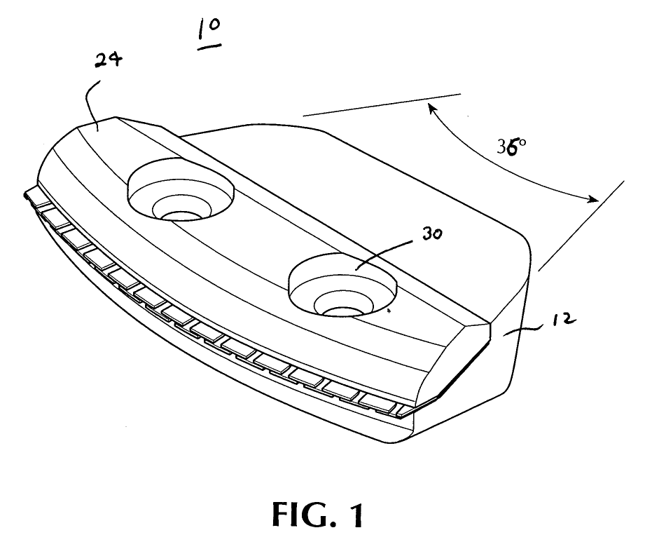

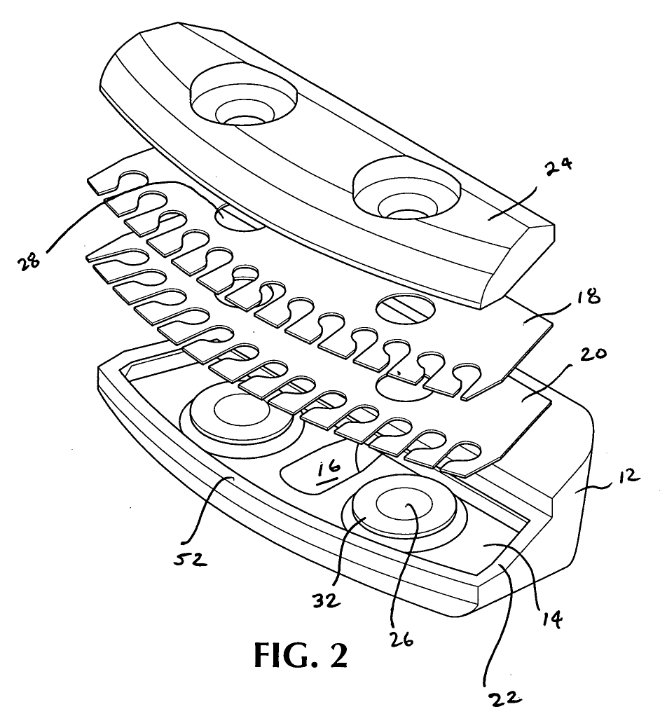

With initial reference to FIGS. 1 and 2, fluid jet nozzle 10 comprises main body 12 having an interior fluid manifold 14 fed by inlet passageway 16 terminating at the rear face of the body. A pair of notched or slotted shims 18, 20 sit on peripheral lip 22 surrounding the manifold 14 of the body, the shims' slots defining an outlet for the nozzle. The shims are maintained in position by holder plank 24, which overlies the shims and provides a top cover and seal for the slots in the shims. Aligned mounting bores 26, 28, 30 in the body, shims and holder plank respectively are provided for nut and bolt pairs to maintain the nozzle in the assembled configuration. Raised bosses 32 about the mounting bores 24 in the body are provided to contact the lower shim 20 and to seal internal manifold 14 against leakage through the mounting bores. The body and holder plank may be fabricated from any appropriate material, including plastics and metals, while the shims are of a flat stock of appropriate flatness and hardness to maintain dimensional stability under working pressure.

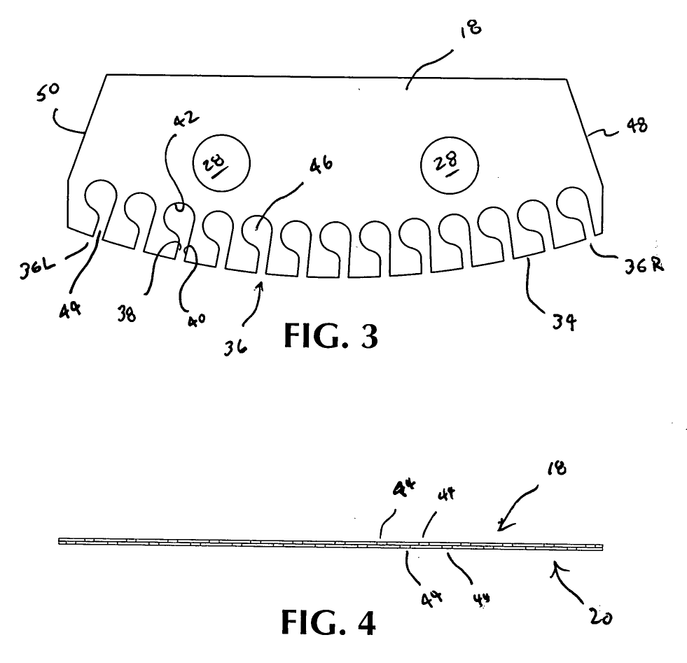

As further detailed in FIG. 3, each of the shims has a series of slots 36 terminating at shim front edge 34. The slots are preferably evenly spaced along the shim, and each slot comprises a rear chamber portion 46 defined by generally circular slot edge portion 42 and an outlet aperture portion 44 defined by a pair of forward slot edges 38, 40. The outlet aperture is laterally offset from the rear chamber.

As may be seen in FIG. 3, due to the offset nature of the outlet apertures with respect to the rear chamber portions of a slot, the outlet apertures of the slots in shim 18 have a right side bias, reflected by the fact that the outlet aperture of rightmost slot 36R is closer to the right edge 48 of the shim than the outlet aperture of leftmost slot 36L is to the left edge 50 of the shim. Thus, simple inversion of shim 18 provides the orientation expressed by second shim 20. Such inversion offsets the outlet apertures in shim 20 to the left as seen in FIG. 2, and in the opposite sense from the offset in shim 18. This can be further seen in FIGS. 1 and 4, whereby the outlet apertures 44 in upper shim 18 are aligned with the inter-slot shim portions of second, lower shim 20, and vice versa. With the shims in place in the nozzle the top and bottom of an outlet aperture in a shim is bounded by either the forward wall portion 52 of lip 22 or the forward edge of holder plank 24 and the inter-notch portion of the other shim, forming an independent series of outlets along each of the shims.

While each of the outlet apertures 44 are independent, the circular chamber portions 46 of corresponding slots in the two shims are in register, thus allowing the compressed fluid from the manifold to pass into the circular chambers of both shims and to then exit the nozzle through the parallel but offset series of outlet apertures in both shims.

The front edge of the shims, along with the corresponding front edges of the holder plank 24 and body 12, may be arcuate. In a preferred embodiment, the subtended arc may be approximately 36 degrees with a 3-inch radius, providing an expanding jet. The shim may be on the order of 2 inches long, with a thickness of 0.005 inch. As shown, each shim has 13 notches, with a total outlet aperture cross-sectional area of 3.3 mm². At an applied air pressure of 40 psi, air usage is below 4.5 scfm.

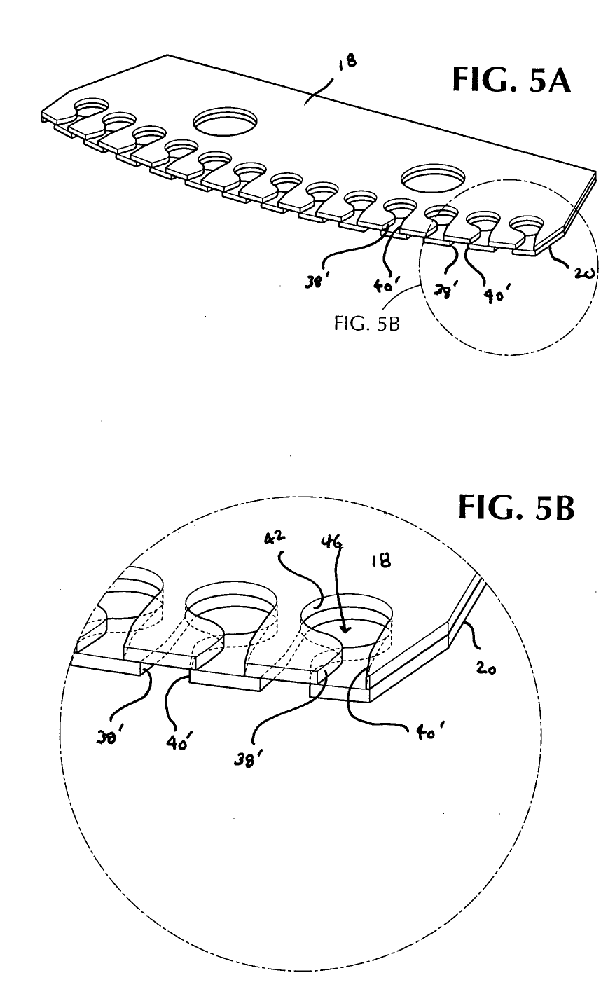

While the embodiment shown in FIG. 3 shows edges 38 and 40 parallel to each other, they can also form a planar, convergent-divergent profile as depicted in FIGS. 5A and 5B that may improve the efficiency of each individual aperture. As depicted therein, the circular edge 42 of rear chamber portion 46 creates a convergent flow of the compressed air as it passes out of the rear chamber, while the opposed slot edges 38′ and 40′ are slightly flared outwardly, allowing a divergent flow to be developed.

Both shim thickness and outlet aperture size may be varied. The greater the number of slots and the thinner the shims, the more uniform the output flow. Conversely, the fewer the slots and the narrower their width and height, the lesser volume of compressed air needed to achieve high exit velocity, with the drawback that narrow passages clog quickly if the filtering system for the compressed air is inadequate or not properly maintained. The shim thickness may preferably be between 0.001 and 0.040 inch, and it has been found that an efficient balance between flow quality and volume is established with an aperture width of between 0.005 and 0.070 inch.

Additional shims can also be utilized to further increase the height of the jet, the offset relationship between the outlet apertures of adjacent shims being maintained. The widths of individual outlet aperture slots can also be varied to further contour the flow rate across the flow footprint.

As may be seen in FIG. 1, the front edges 34 of the shims preferably extend beyond the forward edges of the holder plank 24 and body 12. This provides a flow transition from a fully bounded exit aperture to a channel with a pair of open sides to an ambient medium. The jet in the channel entrains the surrounding medium and gains volume. The overall flow includes both the originally supplied compressed fluid flow and the additional induced flow of the surrounding ambient medium. Thus, the present construction can achieve a high jet range without excessive use of compressed air, the dispersion being accommodated and controlled by the arcuate construction of the nozzle front face.

I claim:

1. A fluid nozzle, comprising a body having a fluid manifold, a pressurized fluid inlet coupled to the manifold, and a first and second parallel series of outlet apertures coupled to the manifold, the outlet apertures of the first series being laterally offset from the outlet apertures of the second series.

2. The nozzle of claim 1, wherein an outlet aperture is a part of an elongated slot of planar configuration having a convergent-divergent channel.

3. The nozzle of claim 1, wherein the first series of outlet apertures is located in a first shim and the second series of outlet apertures is located in a second shim.

4. The nozzle of claim 3, wherein an outlet aperture is a part of an elongated slot of planar configuration having a convergent-divergent channel.

5. The nozzle of claim 3, wherein the outlet apertures are rectangular in cross section.

6. The nozzle of claim 3, further comprising a holder plank for mounting the shims upon the body.

7. The nozzle of claim 3, wherein an outlet aperture comprises a part of an elongated slot in a shim, the slot having an enlarged portion in fluid communication with the manifold.

8. The nozzle of claim 7, wherein the enlarged portions of the slots in the first shim are aligned with the enlarged portions of the notches in the second shim.

9. The nozzle of claim 2, wherein the outlet apertures in a shim terminate at a front edge of the shim, the front edge of the shim projecting beyond a front edge of the body.

10. The nozzle of claim 9, wherein the front edge of the shim is arcuate.

11. The nozzle of claim 10, wherein the front edge of the shim subtends an arc of about 36 degrees.

12. A shim set for use in a nozzle for pressurized fluid having a fluid inlet, a manifold and a shim set having outlet means for the nozzle, the shim set comprising first and second adjacent planar shim members, each of the members having a plurality of spaced slots having opposed edge portions defining sides of outlet apertures for the nozzle and terminating at a front edge of the shim, each of the slots being in fluid communication with the manifold,
the slots in the first and second shim members being oriented such that, with the shims in a face to face aligned contacting relationship and positioned in the nozzle, the slots of the first member are offset from the slots of the second member to form two independent series of outlet apertures.

13. The shim set of claim 12, wherein the shims are dimensioned such that the front edges of the shims extend beyond a forward edge of the nozzle body.

14. The shim set of claim 12 wherein a slot includes an enlarged rear portion for fluid communication with the nozzle manifold.

15. The shim set of claim 14, wherein the enlarged rear portions of the slots of the first shim are positioned to be aligned with the enlarged rear portions of the notches of the second shim when installed in the nozzle.

16. The shim set of claim 12, wherein the slots are of an elongated planar configuration having a convergent-divergent channel.

17. The shim set of claim 12, wherein the opposed slot edge portions defining sides of outlet apertures are parallel.
